(19) United States
(12) Patent Application Publication
(10) Pub. No.: US 2016/0274478 A1
(43) Pub. Date: Sep. 22, 2016

(54) POROUS RESIN PARTICLES

(71) Applicant: Xerox Corporation, Norwalk, CT (US)

(72) Inventors: David J.W. Lawton, Stoney Creek (CA); Chieh-Min Cheng, Rochester, NY (US); David R. Kurceba, Hamilton (CA); Eric J. Young, Webster, NY (US)

(21) Appl. No.: 15/171,459

(22) Filed: Jun. 2, 2016

Related U.S. Application Data
(63) Continuation of application No. 14/057,137, filed on Oct. 18, 2013.

(51) Int. Cl. G03G 9/08; G03G 9/087

(52) U.S. Cl. CPC G03G 9/0825; G03G 9/08755; G03G 9/0819; G03G 9/0804

(57) ABSTRACT

Porous resin particles of from about 3 μm to about 25 μm size made in an emulsion aggregation process where coalescence occurs under continuous conditions which enable, for example, more rapid coalescence, are described.

### RELATED APPLICATION

The instant application is related to copending application entitled, “Continuous Toner Coalescence Processes,” having Att. Docket No. 20121479USNP-XER2976US01, the entire content of which is incorporated herein by reference in entirety.

### FIELD

The present disclosure relates to uniform populations of smaller porous resin particles made using emulsion/aggregation (EA) processes comprising continuous coalescence, which porous polyester resin particles of narrow particle size distribution can be used to make toner.

### BACKGROUND

Processes for forming resin compositions include E/A processes involve preparing an emulsion of ingredients, such as, a surfactant, a monomer and a seed resin in water. The monomer is polymerized to form a latex. The emulsion is then aggregated and coalesced to obtain a slurry of resin particles. Particle size, particle shape and size distribution can be manipulated. However, populations of particles may not be uniform or there may be production variability.

Current E/A processes are generally performed as batch processes, which begin with a bulk polycondensation polymerization in a batch reactor at an elevated temperature. The time required for the polycondensation reaction can be long due to heat transfer of the bulk material, high viscosity and limitations on mass transfer. The resulting resin is then cooled, and can be crushed and milled prior to being dissolved in a solvent. The dissolved resin is then subjected to a phase inversion process where the resin is dispersed in an aqueous phase to prepare a latex. The solvent is then removed from the aqueous phase by a distillation method. Porous polymer particles normally produced by such methods result in relatively large particles (100-10,000 μm) with broad particle size distribution.

There are numerous applications in, for example, chemistry and environmental engineering for porous microspheres and particles in the size range of 5-20 μm of high surface area with narrow particle size distribution. However, the preparation of porous particles in that size range is difficult, expensive and limited.

Porous particles in that size range produced reproducibly in a rapid process would be beneficial for chemical, biochemical and environmental engineering applications.

### SUMMARY

The disclosure provides uniform populations of resin particles, wherein the resin particles comprise a D50 of from about 3 μm to about 25 μm in size, pores less than about 500 Å in diameter, a pore volume of greater than about 0.1 ml/g, a population geometric standard deviation, either number or volume, of less than about 1.35 or any combination thereof.

### DETAILED DESCRIPTION

The present disclosure relates to porous microspheres in the size range of from about 3 to about 25 μm. The present disclosure takes advantage of an emulsion aggregation (EA) process for making toner comprising continuous coalescence at higher temperatures to create uniform populations of porous particles in rapid and reproducible fashion. Short residence times during coalescence of the particles in a flow-through-type continuous system under higher temperatures control surface degradation and porosity, processes that occur on too short of a time scale to be realized in a batch process. Rapid temperature reduction when coalescence is completed can be advantageous, for example, preserving the number of and conformation of pores on the particle surface.

The porous resin particles can find use in the fields of or used for, for example, ion exchange, adsorbents, chromatography, for example, for sizing molecules, bioprocessing, carrying immobilized enzymes or other biological molecules, drug delivery, catalysis and so on, essentially can replace any known particles and/or beads and any current uses thereof, such as, when the current particles are porous. In embodiments, porous particles may provide advantages over non-porous particles or beads, for example, by expanding the surface area of the particles or beads.

Although specific terms are used in the following description for the sake of clarity, the terms are intended to refer only to the particular structure of the embodiments selected for illustration and are not intended to define or to limit the scope of the disclosure. In the following description, like numeric designations refer to components of like function.

“Population,” refers to a collection of resin particles obtained in a process of interest. The collection of particles can comprise one or more polymers, and depending on the use, can comprise other components, such as, colorant, wax, surfactant and so on when the resin particles are used to construct toner. The population of resin particles can comprise a shell, and can comprise surface additives and/or modifications so long as the population is one obtained directly from a continuous coalescence process as taught herein.

By, “non-classified,” is meant that the population of resin panicles is not sized, categorized, purified or treated in any way following coalescence and prior to determining the metrics of particle size of the population of particles.

The singular forms “a,” “an,” and, “the,” include plural referents, unless the context clearly dictates otherwise.

“Fines,” or “fine content,” refers to particles smaller than those desired. Hence, a substantial fine particle content could provide for a particle size distribution that comprises more than one peak or more of particles, or a single peak, in a graphical distribution with a curve of increasing particle size to the right, with a shoulder or tail to the left of the mean or average particle size, or the peak is broader with a larger standard deviation, which can be manifest by a curve that is skewed to the left.

“Coarse,” or, “coarse content,” refers to particles larger than those desired. Hence, a substantial coarse particle content could provide for a particle size distribution that comprises more than one peak or more of particles, or a single peak, in a graphical presentation with a curve of increasing particle size to the right, with a shoulder or tail to the right of the mean or average particle size, or the peak is broader with a larger standard deviation, which can be manifest by a curve that is skewed to the right.

Numerical values in the specification and claims of the instant application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of, “from 2 grams to 10 grams,” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

A value modified by a term or terms, such as, “about,” and, “substantially,” may not be limited to the precise value specified but can comprise a range that varies 10% from the stated value. The approximating language may correspond to the precision of an instrument for measuring the value. The modifier. “about,” should also be considered as disclosing the range defined by the absolute values of the two endpoints. For example, the expression, “from about 2 to about 4,” also discloses the range, “from 2 to 4.”

The processes for making toner disclosed herein are used to produce resin particles, as well as porous resin particles. An aggregated particle slurry is obtained by any known process, such as, a batch process or a continuous process. Aggregated particles can be used fresh, that is, used without interruption after particle growth is halted and the aggregated particles are introduced without delay to a continuous coalescence device and process of interest, or the aggregated particles can be stored, such as, a slurry of aggregated particles that are maintained, for example, for a period of time under reduced temperature. The slurry or emulsion can be maintained with periodic or continuous stirring or mixing. In the case of a stored preparation, the slurry can be warmed to room temperature or can be heated to about 40° C. to about 50° C. or more prior to coalescence. The temperature of the heated stored aggregated particle slurry can approximate that used during freezing of particle growth following aggregation.

The aggregated particle slurry is moved into a continuous reactor of interest, which can take any form using any known device so long as the reaction occurs as and in a continuous fluid stream. In the first stage, the slurry is passed through a device that comprises a temperature regulating device, such as, a heat exchanger, wherein the slurry temperature is raised to at least about 120° C., at least about 125° C., at least about 130° C. or higher to enable a more rapid coalescence of the particles. The higher temperatures facilitate more rapid coalescence and generation and/or maintenance of pores in the resin.

The residence time of the slurry in a continuous reactor comprising the first temperature regulating device is configured to correspond to the time needed to obtain the desired coalescence of the resin particles. As known in the art, the residence time of a slurry in any one part of a continuous reactor can depend on slurry viscosity, any pressure used to move the slurry therethrough, the bore of any conduits, length of any conduits and so on. Hence, coalescence can be completed while the slurry is in a portion of a continuous device comprising the first temperature regulating device or in a conduit or reservoir following movement from the device comprising the first temperature regulating device.

In embodiments, the heated aggregated particle slurry optionally can flow into and/or through a residence time reactor wherein the aggregated particles are afforded more time to coalesce. Generally, the temperature of the residence time reactor is the same as that provided by the first temperature regulating device, and temperature maintenance can be provided by a second temperature regulating device, or by providing vessels and conduits that are insulated so the temperature of reactants within are maintained while passing therethrough. Residence time in the residence time reactor is determined by the total time needed to complete coalescence of the particles. Coalescence completion is determined as a design choice based on a desired property or properties, such as, a certain porosity, surface area, circularity and so on or any combination thereof as a design choice.

The coalesced particle slurry then is passed through a portion of the device comprising a second (or third if a residence time reactor is present) temperature regulating device, such as, a heat exchanger, which reduces slurry temperature to quench coalescence of the resin particles, which temperature can be about 40° C. or at least below the Tg of the resin(s) in the particles. In embodiments, the coalesced particle slurry is passed directly into a collection vessel that is at a reduced temperature to quench coalescence, for example, the outflow of the continuous reactor can be transferred to an ice water bath for a rapid quenching of temperature at the conclusion of coalescence. The rapidity of coalescence, rapid termination of coalescence, reduction of mixture temperature to near or at room temperature (RT) or combination thereof contribute to pore generation and/or retention or maintenance of pores in the resin particles.

The continuous process is simple, requires fewer devices, thus reducing production cost, and provides high yield. Because smaller quantities of material are processed at a time, quality control is easier to manage. Lot-to-lot variation can be reduced due to control of temperature and other process parameters. In contrast, the process controls of a reaction vessel in a batch process can only be provided along the surfaces of the reaction vessel causing regional microenvironments of different conditions in various areas and regions within the batch reactor, such as, between the material near the sides of the reaction vessel and the material in the center of the reaction vessel.

### The Aggregated Particle Slurry

The processes of the present disclosure begin with an aggregated particle slurry, which travels through at least one temperature regulating device to raise the slurry temperature to the coalescence temperature and then through another temperature regulating device to lower the slurry temperature to, for example, RT. The aggregated particle slurry can be made by any method known in the art using reagents as a design choice, such as, a polyester resin or resins and other reagents or reactants as needed or desired. The aggregated particles include one or more resins (i.e. latex) and optionally, in the case of toner, one or more of an emulsifying agent (i.e. surfactant), a colorant, a wax, an aggregating agent, a coagulant and/or additives. Generally, the aggregation is terminated, for example, by elevating the pH of the slurry, raising the temperature of the slurry or both, for example, as known in the an. The aggregated particle slurry contains aggregated particles in a solvent, such as, water.

Particles of the instant disclosure comprise any known polymeric material that can be used in an EA process, such as, a polyester. In embodiments, other non-polyester resins known in the art can be used, such as, polystyrenes, polyacrylates and so on, as well as combinations thereof with a polyester, for example, and so on suitable for such use. The disclosure herein is exemplified with polyesters.

Any monomers suitable for preparing a polyester latex, such as, a diacid and a diol, may be used to form the aggregated particles. Preformed polyester polymers can be dissolved in a solvent. Any polymer or resin or combination of polymers or resins that can be commended to the instant process to yield a porous particle of interest can be used.

In embodiments, the latex may include at least one polymer, including from 1 to about 20 different polymers, from about 2 to about 10 different polymers. For example, a resin particle can comprise a crystalline resin and one or more amorphous resins, such as, at least two amorphous resins. The polymer utilized to form the latex may be a polyester resin, including the resins described in U.S. Pat. Nos. 6,593,049 and 6,756,176, the disclosure of each of which hereby is incorporated by reference in entirety. The latex may also include a mixture of an amorphous polyester resin and a crystalline polyester resin as described in U.S. Pat. No. 6,830,860, the disclosure of which hereby is incorporated by reference in entirety.

When at least two amorphous polyester resins are utilized, one of the amorphous polyester resins may be of high molecular weight (HMW) and the second amorphous polyester resin may be of low molecular weight (LMW). An HMW amorphous resin may have, for example, a weight average molecular weight (M_{w}) greater than about 55,000, as determined by gel permeation chromatography (GPC). An HMW amorphous polyester resin may have an acid value of from about 8 to about 20 mg KOH/grams. HMW amorphous polyester resins are available from a number of commercial sources and can possess various melting points of, for example, from about 30° C. to about 140° C.

An LMW amorphous polyester resin has, for example, an M_{w} of 50,000 or less. LMW amorphous polyester resins, available from commercial sources, may have an acid value of from about 8 to about 20 mg KOH/grams. The LMW amorphous resins can possess an onset T_{g} of, for example, from about 40° C. to about 80° C., as measured by, for example, differential scanning calorimetry (DSC).

In embodiments, a polyester resin is formed by polycondensation of a diol and a diacid in the presence of an optional catalyst as known in the art. For forming a crystalline polyester, suitable organic diols include aliphatic diols with from about 2 to about 36 carbon atoms, such as, 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol and the like; alkali sulfo-aliphatic diols such as sodium 2-sulfo-1,2-ethanediol, lithium 2-sulfo-1,2-ethanediol, potassium 2-sulfo-1,2-ethanediol, sodium 2-sulfo-1,3-propanediol, lithium 2-sulfo-1,3-propanediol, potassium 2-sulfo-1,3-propanediol, mixture thereof, and the like. The aliphatic diol may be, for example, selected in an amount of from about 40 to about 60 mole percent of the resin, and any alkali sulfo-aliphatic diol when present, may be selected in an amount of from about 1 to about 10 mole percent of the resin.

Examples of diacids or diesters selected for the preparation of the crystalline resins include oxalic acid, succinic acid, glutaric acid, adipic acid, suberic acid, azelaic acid, sebacic acid, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid, such as, the sodium, lithium or potassium salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfoterephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate or mixtures thereof. The diacid may be selected in an amount of, for example, from about 40 to about 60 mole percent of the resin, and when present, the alkali sulfo-aliphatic diacid may be selected in an amount of from about 1 to about 10 mole percent of the resin.

Examples of crystalline resins include polyamides, polyimides, polyolefins, polyethylenes, polybutylenes, polyisobutyrates, ethylene-propylene copolymers, ethylene-vinyl acetate copolymers, polypropylene, mixtures thereof and the like. Specific crystalline resins comprise poly(ethylene-adipate), polypropylene-adipate), poly(butylene-adipate), poly(pentylene-adipate), poly(hexylene-adipate), poly(octylene-adipate), poly(ethylene-succinate), polypropylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinamide) and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide) and poly(butylene-succinimide).

The crystalline resin may be present in an amount of from about 5 to about 30 percent by weight of the toner components (i.e. the slurry less the aqueous phase, that is, the solids content), from about 15 to about 25 percent by weight. The crystalline resin may possess various melting points of from about 30° C. to about 120° C., from about 50° C. to about 90° C. The crystalline resin may have a number average molecular weight (Mₙ), as measured by gel permeation chromatography (GPC) of from about 1,000 to about 50,000, from about 2,000 to about 25,000, and a weight average molecular weight (M_{w}) of from about 2,000 to about 100,000, from about 3,000 to about 80,000, as determined by GPC. The molecular weight distribution (M_{w}/Mₙ) of the resin may be from about 2 to about 6, from about 3 to about 5.

The polyester resin may be an amorphous polyester. Examples of diacid or diesters selected for the preparation of amorphous polyesters include dicarboxylic acids or diesters, such as, terephthalic acid, phthalic acid, isophthalic acid, fumaric acid, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethyl succinate, dimethylfumarate, dimethylmaleate, dimethylglutarate, dimethyladipate, dimethyl dodecylsuccinate and combinations thereof. The diacid or diester may be selected, for example, from about 40 to about 60 mole percent of the resin.

Examples of diols in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene and combinations thereof. The amount of diol may be from about 40 to about 60 mole percent of the resin.

Examples of other amorphous resins which may be utilized include metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate) and copoly(propylene-butylene-terephthalate)-copoly(propylene-butylene-5-sulfo-isophthalate), and wherein the alkali metal is, for example, a sodium, lithium or potassium ion.

The latex can comprise biodegradable reagents, such as, those obtained from plants or microbial sources resulting in resin particles with a lower environmental burden. Naturally occurring diacids are known, such as, azelaic acid, as are naturally occurring diols, such as, isosorbide. A resin of interest may be, “bio-based,” which a commercial or industrial product (other than food or feed) that is composed, in whole or in substantial part (e.g., at least about 50%, at least about 60%, at least about 70%, at least about 80/o, at least 90% by weight of the resin), of biological products or renewable domestic agricultural materials (including plant, animal, and marine materials). Generally, a bio-based material is biodegradable, that is, substantially or completely biodegradable, by substantially is meant greater than 50%, greater than 60%, greater than 70% or more of the material is degraded from the original molecule to another form by a biological or environmental means, such as, action thereon by bacteria, animals, plants and so on in a matter of days, matter of weeks, a year or more.

Other suitable resins that can be used to make the porous particles of interest, such as, in combination with a one or more polyesters, comprise a styrene, an acrylate, such as, an alkyl acrylate, such as, methyl acrylate, ethyl acrylate, butyl acrylate, isobutyl acrylate, dodecyl acrylate, n-octyl acrylate, n-butylacrylate, 2-chloroethyl acrylate, β-carboxy ethyl acrylate (β-CEA), phenyl acrylate, methacrylate and so on; a butadiene, an isoprene, an acrylic acid, an acrylonitrile, a styrene acrylate, a styrene butadiene, a styrene methacrylate, and so on, such as, methyl α-chloroacrylate, methyl methacrylate, ethyl methacrylate, butyl methacrylate, butadiene, isoprene, methacrylonitrile, acrylonitrile, vinyl ethers, such as, vinyl methyl ether, vinyl isobutyl ether, vinyl ethyl ether and the like; vinyl esters, such as, vinyl acetate, vinyl propionate, vinyl benzoate and vinyl butyrate; vinyl ketones, such as, vinyl methyl ketone, vinyl hexyl ketone, methyl isopropenyl ketone and the like; vinylidene halides, such as, vinylidene chloride, vinylidene chlorofluoride and the like; N-vinyl indole, N-vinyl pyrrolidone, methacrylate, acrylic acid, methacrylic acid, acrylamide, methacrylamide, vinylpyridine, vinylpyrrolidone, vinyl-N-methylpyridinium chloride, vinyl naphthalene, p-chlorostyrene, vinyl chloride, vinyl bromide, vinyl fluoride, ethylene, propylene, butylene, isobutylene and mixtures thereof. A mixture of monomers can be used to make a copolymer, such as, a block copolymer, an alternating copolymer, a graft copolymer and so on.

The resulting polyester latex may have acid groups. Acid groups include carboxylic acids, carboxylic anhydrides, carboxylic acid salts, combinations thereof and the like. The number of carboxylic acid groups may be controlled by adjusting the starting materials and reaction conditions to obtain a resin that possesses desired characteristics. Those acid groups may be partially neutralized by the introduction of a neutralizing agent, such as, a base solution or a buffer, during neutralization (which can occur prior to aggregation). Suitable bases include, but are not limited to, ammonium hydroxide, potassium hydroxide, sodium hydroxide, sodium carbonate, sodium bicarbonate, lithium hydroxide, potassium carbonate, triethylamine, triethanolamine, pyridine and derivatives, diphenylamine and derivatives, poly(ethylene amine) and derivatives, combinations thereof and the like. Those compounds can be dissolved in a suitable solvent, such as, water, alone or in combination to form a buffer. After neutralization, the hydrophilicity, and thus the emulsifiability of the resin, may be improved when compared to a resin that did not undergo such neutralization process.

An emulsifying agent may be present in the aggregated particle slurry and may include any surfactant suitable for use in forming a latex resin. Surfactants which may be utilized include anionic, cationic and/or nonionic surfactants.

Anionic surfactants include sulfates and sulfonates, sodium dodecyl sulfate (SDS), sodium dodecylbenzene sulfonate, sodium dodecylnaphthalene sulfate, dialkyl benzenealkyl sulfates and sulfonates, acids, such as, abitic acid, combinations thereof and the like. Other suitable anionic surfactants include DOWFAX® 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of the surfactants may be used.

Examples of nonionic surfactants include, but are not limited to alcohols, acids and ethers, for example, polyvinyl alcohol, polyacrylic acid, methalose, methyl cellulose, ethyl cellulose, propyl cellulose, hydroxylethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, mixtures thereof and the like.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, and C₁₂,C₁₅,C₁₇-trimethyl ammonium bromides, mixtures thereof and the like. Other cationic surfactants include cetyl pyridinium bromide, halide salts of quaternized polyoxyethylalkylamines, dodecylbenzyl triethyl ammonium chloride, and the like, and mixtures thereof. The choice of surfactants or combinations thereof as well as the amounts of each to be used are within the purview of those skilled in the art.

A colorant may be present in the aggregated particle slurry and include pigments, dyes, mixtures of pigments and dyes, mixtures of pigments, mixtures of dyes and the like. The colorant may be, for example, carbon black, cyan, yellow, magenta, red, orange, brown, green, blue, violet or mixtures thereof.

The colorant may be present in the aggregated particle slurry in an amount of from 0 to about 25 percent by weight of solids (i.e. the solids), in an amount of from about 2 to about 15 percent by weight of solids.

Exemplary colorants include carbon black like REGAL 330® magnetites; Mobay magnetites including MO08029™ and MO8060™; Columbian magnetites: MAPICO BLACKS™ and surface treated magnetites; Pfizer magnetites including CB4799™, CB5300™, CB5600™ and MCX6369™; Bayer magnetites including, BAYFERROX 8600™ and 8610™; Northern Pigments magnetites including, NP604™ and NP608™; Magnox magnetites including TMB-100™ or TMB-104™, HELIOGEN BLUE L6900™, D6840™, D7080™, D7020™, PYLAM OIL BLUE™, PYLAM OIL YELLOW™ and PIGMENT BLUE 1™ available from Paul Uhlich and Company, Inc.; PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Calif.; NOVAPERM YELLOW FGL™ and HOSTAPERM PINK E™ from Hoechst; and CINQUASIA MAGENTA™ available from E.I. DuPont de Nemours and Company. Other colorants include 2,9-dimethyl-substituted quinacridone and anthraquinone dye identified in the Color Index as CI-60710, CI Dispersed Red 15, diazo dye identified in the Color Index as CI-26050, CI Solvent Red 19, CI 12466, also known as Pigment Red 269, CI 12516, also known as Pigment Red 185, copper tetra(octadecyl sulfonamido) phthalocyanine, x-copper phthalocyanine pigment listed in the Color Index as CI-74160, CI Pigment Blue, Anthrathrene Blue identified in the Color Index as CI-69810, Special Blue X-2137, diarylide yellow 3,3-dichlorobenzidene acetoacetanilides, a monoazo pigment identified in the Color Index as CI 12700, CI Solvent Yellow 16, CI Pigment Yellow 74, a nitrophenyl amine sulfonamide identified in the Color Index as Foron Yellow SE/GLN, CI Dispersed Yellow 33,2,5-dimethoxy-4-sulfonanilide phenylazo-4′-chloro-2,5-dimethoxy acetoacetanilide, Yellow 180 and Permanent Yellow FGL. Organic soluble dyes having a high purity for the purpose of color gamut which may be utilized include Neopen Yellow 075, Neopen Yellow 159, Neopen Orange 252, Neopen Red 336, Neopen Red 335, Neopen Red 366, Neopen Blue 808, Neopen Black X53 and Neopen Black X55.

A wax also may be present in the aggregated particle slurry. Suitable waxes include, for example, submicron wax particles in the size range of from about 50 to about 500 nm, from about 100 to about 400 nm. A wax can have a lower melting point for use in low melt and ultra low melt toner.

The wax may be, for example, a natural vegetable wax, natural animal wax, mineral wax and/or synthetic wax. Examples of natural vegetable waxes include, for example, carnauba wax, candelilla wax, Japan wax and bayberry wax. Examples of natural animal waxes include, for example, beeswax, punic wax, lanolin, lac wax, shellac wax and spermaceti wax. Mineral waxes include, for example, paraffin wax, microcrystalline wax, montan wax, ozokerite wax, ceresin wax, petrolatum wax and petroleum wax. Synthetic waxes of the present disclosure include, for example, Fischer-Tropsch wax, acrylate wax, fatty acid amide wax, silicone wax, polytetrafluoroethylene wax, polyethylene wax, polypropylene wax and mixtures thereof.

Examples of polypropylene and polyethylene waxes include those commercially available from Allied Chemical and Baker Petrolite, wax emulsions available from Michelman Inc. and the Daniels Products Company, EPOLENE N-15 commercially available from Eastman Chemical Products, Inc., Viscol 550-P, a low weight average molecular weight polypropylene available from Sanyo Kasel K.K., and similar materials.

In embodiments, the waxes may be functionalized. Examples of groups added to functionalize waxes include amines, amides, imides, esters, quaternary amines, and/or carboxylic acids. In embodiments, the functionalized waxes may be acrylic polymer emulsions, for example, Joncryl 74, 89, 130, 537 and 538, all available from Johnson Diversey, Inc., or chlorinated polypropylenes and polyethylenes commercially available from Allied Chemical and Petrolite Corporation and Johnson Diversey, Inc.

The wax may be present in an amount of from 0 to about 30 percent by weight of solids, from about 2 to about 20 percent by weight of solids in the slurry.

An aggregating agent may be present in the aggregated particle slurry. Any aggregating agent capable of causing complexation can be used. Alkali earth metal or transition metal salts may be utilized as aggregating agents. Such salts include, for example, beryllium halides, beryllium acetate, beryllium sulfate, magnesium halides, magnesium acetate, magnesium sulfate, calcium halides, calcium acetate, calcium sulfate, strontium halides, strontium acetate, strontium sulfate, barium halides, and optionally mixtures thereof. Examples of transition metal salts or anions which may be utilized as aggregating agent include acetates of vanadium, niobium, tantalum, chromium, molybdenum, tungsten, manganese, iron, ruthenium, cobalt, nickel, copper, zinc, cadmium or silver; acetoacetates of vanadium, niobium, tantalum, chromium, molybdenum, tungsten, manganese, iron, ruthenium, cobalt, nickel, copper, zinc, cadmium or silver, sulfates of vanadium, niobium, tantalum, chromium, molybdenum, tungsten, manganese, iron, ruthenium, cobalt, nickel, copper, zinc, cadmium or silver; and aluminum salts, such as, aluminum acetate, aluminum halides such as polyaluminum chloride, mixtures thereof and the like. Other examples of aggregating agents include polymetal halides, polymetal sulfosilicates, monovalent, divalent or multivalent salts optionally in combination with cationic surfactants, mixtures thereof, and the like. Inorganic cationic coagulants include, for example, polyaluminum chloride (PAC), polyaluminum sulfo silicate (PASS), aluminum sulfate, zinc sulfate, or magnesium sulfate.

For example, the slurry may include an anionic surfactant, and the counterionic coagulant may be a polymetal halide or a polymetal sulfo silicate. When present, the coagulant is used in an amount from about 0.01 to about 2% by weight of solids, from about 0.1 to about 1.5% by weight of solids. The coagulant may prevent/minimize presence of fines.

A charge additive in an amount of from about 0 to about 10 weight percent, from about 0.5 to about 7 weight percent of solids can be present in the resin particles. Examples of such charge additives include alkyl pyridinium halides, bisulfates, negative charge enhancing additives like aluminum complexes, and the like. Examples of such surface additives include, for example, metal salts, metal salts of fatty acids, colloidal silicas, metal oxides, strontium titanates, mixtures thereof, and the like. Surface additives may be present in an amount of from about 0.1 to about 10 weight percent, from about 0.5 to about 7 weight percent of solids. Other additives include zinc stearate and AEROSIL R972® available from Degussa. The coated silicas of U.S. Pat. Nos. 6,190,815 and 6,004,714, the disclosure of each of which hereby is incorporated by reference in entirety, may also be present in an amount of from about 0.05 to about 5 percent, from about 0.1 to about 2 percent of solids.

Hence, as known in the art, the resin(s) are dissolved or presented in a solvent, along with any other reagents as desired, for example, for making toner, a colorant, a surfactant and a wax, and the mixture is allowed to form particles, such as, at a lower pH, at lower temperatures, such as RT, or both. The resins aggregate from nm-sized particles to form μm-sized particles. The pH can be about no higher than about 4.2, no higher than about 4.4, no higher than about 4.6, no higher than about 4.8 or higher, but generally no higher than about 5.5. The acidic conditions may contribute to pore formation, for example, by hydrolysis of polyester polymers. The temperature can be no higher than about 40° C., no higher than about 42° C., no higher than about 44° C., no higher than about 46° C.

Optionally, a shell resin can be applied to the aggregated particles. Any known resin(s) can be used to form the shell, which can be applied practicing methods known in the art.

Once the desired particle size is obtained, particle growth is halted, for example, by raising the pH of the emulsion or slurry by adding a base or a buffer. The pH can be raised, for example, to at least about 7, at least about 7.4, at least about 7.6, at least about 7.8 or higher.

A chelator, such as, ethylenediamine tetraacetic acid (EDTA), gluconal, hydroxyl-2,2′iminodisuccinic acid (HIDS), dicarboxylmethyl glutamic acid (GLDA), methyl glycidyl diacetic acid (MGDA), hydroxydiethyliminodiacetic acid (HIDA), sodium gluconate, a citrate and so on can assist in controlling pH, sequester cation or both when stopping particle growth.

The slurry can contain from about 10 wt % to about 50 wt % of solids, from about 20 wt % to about 40 wt % of solids in a solvent (typically water) although solids amounts outside of those ranges can be used, for example, to control fluid flow through the continuous reactor.

The resulting aggregated particle slurry, as taught hereinabove, came be transferred to a continuous reactor or interest or stored, with optional stirring and/or mixing, with an optional reduction in temperature, prior to transfer to a continuous reactor of interest.

### Continuous Coalescence Process

The continuous coalescence processes of the present disclosure begin with preparing the aggregated particle slurry to be used in a continuous coalescence system of the present disclosure. The aggregated particles can be made by any process, for example, either by a batch or a continuous process. The aggregated particles can be made and stored prior to coalescence, for example, under reduced temperature, or may be used directly after production.

Any known continuous process or apparatus can used to practice the continuous coalescence processes of the present disclosure. The continuous device comprises one or more temperature controlling or regulating devices to manipulate the temperature of the slurry within. Any known temperature controlling or regulating device can be used, such as, a shell-tube heat exchanger, a spiral heat exchanger, a plate-and-frame heat exchanger and so on, as known in the art. A holding tank, a pump and a receiving tank may also be used with the apparatus of interest. Where particle formation and aggregation occur in a batch reactor, the holding tank may be the batch reactor in which the aggregated particles were made.

Thus, the aggregated particle slurry may be provided from a holding tank or from a batch or continuous aggregation process that passes directly into the continuous reactor of interest. If the aggregated particle slurry is stored, the slurry can be treated to approximate conditions of freezing of particle growth following aggregation. Thus, for example, if the slurry is maintained under reduced temperature, the slurry is warmed, for example, to room temperature or to a temperature of from about 40° C. to about 50° C.

Coalescence is continuous with the slurry exposed to ramp up temperature to enable coalescence to occur, for example, at a temperature above the Tg of the resin(s) present in the particles, and then the particles are exposed to a temperature below the Tg of the resin(s) to halt coalescence.

The pH of the emulsion/slurry generally is at or near the pH used to terminate particle growth prior to entry into a continuous reactor of interest. Hence, pH for coalescence can be, for example, to at least about 7, at least about 7.4, at least about 7.6, at least about 7.8 or higher. The conditions may be conducive to hydrolysis of polyester resin(s) thereby facilitating formation and/or maintenance of pores on and in the particles.

The aggregated particle slurry is drawn from a reactor or from a holding tank and transported to a continuous reactor of interest where the slurry passes through a first temperature regulating device to raise the slurry temperature to, for example, at least about 120° C., at least about 125° C., at least about 130° C. to enable rapid coalescence.

The heated aggregated particle slurry, having a first elevated temperature to enable coalescence, optionally flows through a residence time reactor which provides a suitable time for a desired level of coalescence to occur. The residence time reactor can comprise a second temperature regulating device. The residence time reactor can be a modified portion of flow path or conduit with an increased inside diameter where flow rate decreases. The local residence time of the slurry in the residence time reactor may be from about 0.5 minute to about 5 minutes, although times outside of that range can be used as a design choice.

Depending on flow rate, size of the flow path, length of the flow path, viscosity of the slurry and so on, coalescence may occur without the need of a residence time rector. Thus, the flow path and conduits from the portion of the device comprising the first temperature regulating device can comprise a second temperature regulating device to ensure the slurry passing therewithin is maintained at the elevated coalescence temperature as transported from the first portion comprising the first temperature controlling device to the second portion for reducing slurry temperature.

After residing in the residence time reactor or passing through the flow path or conduit where coalescence is completed, the coalesced particle slurry can be passed through a portion of the continuous device comprising another temperature regulating device, either a second or third device depending on whether a second temperature controlling device is present in a residence time reactor or on conduits following the initial increase in temperature. The temperature of the slurry now is decreased, for example, to below the Tg of the resin(s) to quench coalescence. The temperature can be below about 40° C. or at RT, such as, from about 20° C. to about 25° C. or cooler. The quenched coalesced particle slurry then exits the continuous apparatus, for example, into a receiving tank.

Alternatively, the quenched particle slurry at elevated temperature can be discharged from the continuous reactor directly into a receiving tank at reduced temperature, such as, a tank comprising iced water, such as, iced deionized (DI) water (DIW) or jacketed to be at a temperature below the Tg of the resin(s) or near RT.

The coalesced particle slurry comprises coalesced particles which have a median diameter (D50) ranging from about 3 μm to about 25 μm, from about 3.5 μm to about 15 μm, from about 4 μm to about 10 μm. The coalesced particle slurry may have a GSDᵥ and/or a GSDₙ of from about 1.05 to about 1.35, from about 1.05 to about 1.3, less than about 1.35, less than about 1.3, less than about 1.25. GSDᵥ refers to the geometric standard deviation by volume. GSDₙ refers to the geometric standard deviation by number. Either value can be obtained practicing known materials and methods, using, for example, commercially available devices, such as, a Beckman Coulter MULTISIZER 3, used as recommended by the manufacturer. The closer to 1.0 the GSD value, the lesser the size dispersion amongst the particles in the population. The particle diameters at which a cumulative percentage of 50% of the total toner particles are attained is defined as volume D₅₀ and the particle diameters at which a cumulative percentage of 84% is attained are defined as volume D₈₄. The coarse content can be represented by the ratio, D₈₄/D₅₀. The fine content can be represented by the ratio, D₅₀/D₁₆. In embodiments, the populations do not contain particles greater than about 16 μm, greater than about 17 μm, greater than about 18 μm, which is more than about twice the D₅₀ of the particles. The amount of fines which are at least about 2 μm less than the D₅₀ in size can be less than about 10% of the population, less than about 8%, less than about 6% of the population of particles. The coalesced particles may have a circularity of from about 0.90 to about 0.99, from about 0.91 to about 0.98. The particles of interest and the population of particles of interest can have any combination of the above metrics.

Circularity may be measured, for example, using a Flow Particle Image Analyzer, commercially available from Sysmex Corporation. The size distribution of the population of particles obtained directly from a continuous reactor of interest is narrow, in embodiments, often only a single population of particles is obtained. Particle size can be determined by any known method and means, for example, by passing a sample through a COULTER COUNTER. Other metrics of particle size distribution can be used, as known in the art, such as, the D₅₀ value, GSDᵥ, GSDₙ and so on, as known in the art.

The obtained particles comprise pores. The pores can be less than about 500 Å in diameter, less than about 400 Å, less than about 300 Å and can have a volume greater than about 0.1 ml/g, greater than about 0.2 ml/g, greater than about 0.3 ml/g. With pores at the particle surface, the BET surface area is greater than about 4 m²/g, greater than about 4.25 m²/g, greater than about 4.5 m²/g. The particles of interest can have any combination of the above metrics.

Particle size measurements and pore size measurements can be obtained practicing known techniques, such as electroacoustics, capillary flow porometry, gas sorption (BET) and so on, using commercially available devices, such as, from Quantachrome (UK), Malvern Instruments (UK), Micromeritics (Norcross, Ga.) and so on.

Pore size, pore volume, pore density on the cell surface and toner surface area can be tuned based on, for example, polyester resin used, time of coalescence, temperature of coalescence, pH of coalescence, rapidity of temperature reduction to stop coalescence or combination thereof.

The resin particles can be washed and dried for storage, or maintained hydrated for storage, in which case, a preservative may be added to the slurry. The hydrated particles can be used for size exclusion chromatography, as an absorbent or adsorbent, a carrier of other compounds, such as, drugs, and when configured to comprise other reagents, can function as toner. The toner particles can be used per se as developer or can be combined with known carriers, which may be coated, to form two part developer.

The continuous coalescence processes of the present disclosure reduces cycle time, reduces downtime due to cleaning, and increases yield of smaller, porous particles. In addition, energy used in heating the slurry can be partially recovered, reducing overall energy consumption and increasing efficiency.

The following examples are for purposes of further illustrating the present disclosure. The examples are merely illustrative and are not intended to limit the disclosure to the materials, conditions, or process parameters set forth therein.

### EXAMPLES

### Example 1

Continuous Coalescence EA Slurry for Porous Particles (pH 7.47, 240 g/min)

A batch-aggregated EA slurry of black toner particles was prepared in a 20 gal reactor. About 8 kg of polyester A (Mw=86,000, Tg onset=56° C., 35% solids), 7.7 kg of polyester B (Mw=-19,400, Tg onset=60° C. 35% solids)), 2 kg crystalline polyester C (Mw=23,300, Mn=10,500, Tm=71° C. 36% solids), 3.2 kg polyethylene wax emulsion (Tm=90° C. 32% solids, IGI), 4.2 kg black pigment (Nipex-35, Evonik, 17% solids), 706 g cyan pigment (PB 15:3 Dispersion. 17% solids) and 28 kg deionized water (DIW) were mixed in a reactor, then pH adjusted to 4.2 using 0.3M nitric acid. The slurry then was stirred with a homogenizer using a recirculating loop for 50 min and then 55 g aluminum sulphate solution in 2.6 kg DIW were added inline. The mixing speed was increased from 85 rpm to 275 rpm once all the coagulant was added. The slurry then was aggregated at a batch temperature of 42° C. During aggregation, a shell-forming mixture comprised of 4.5 kg polyester A emulsion and 4.4 kg polyester B emulsion pH adjusted to 3.3 with nitric acid was added to the batch. The batch was heated further to achieve the targeted particle size. Aggregation was frozen with pH adjustment to 7.8 using NaOH and an EDTA solution (165 g EDTA with 258 g DIW). The batch then was stored, for example, with mixing, and used for subsequent continuous coalescence experiments over a period of several weeks with no degradation in particle size or GSD.

Three liters of the stored aggregated slurry was heated to 65° C. (the pH was 7.47) and placed into the feed reactor, which then was sealed and pressurized to 40 psi. The volumetric flow rate from the feed reactor into the continuous coalescence system was regulated at the outlet of the coalescence device by means of a peristaltic pump to a volumetric flow rate of about 240 mL/min. The first of two heat exchangers was set to 131° C. yielding a slurry outlet temperature of 129° C. The slurry then passed through a residence time unit at the same set temperature and having a volume of about 240 mL/min yielding a residence time of about 1 minute. The slurry then passed directly through the second heat exchanger which was cooled by domestic ambient cold water to quench the slurry temperature to below 40° C. The toner particles were then collected, washed and dried using conventional procedures.

The population of particles was measured and the measurements revealed a D₅₀/GSDᵥ/GSDₙ of 5.95/1.22/1.226. There were no particles greater than 16 μm in size. About 4.45% of the particles were 3 μtm or less in size (a measure of the fines content.) BET analysis determined that the surface area of the porous particles was 11 m²/g. Multipoint analysis estimated a pore size of 250 Å in diameter and a pore volume of 0.1 mL/g.

### Example 2

Continuous Coalescence of EA Slurry (pH 7.07, 240 g/min)

The same materials and method of Example 1 were practiced with the only difference being that pH was 7.07 prior to pressurization of the system.

The population of particles was measured and the measurements revealed a D₅₀/GSDᵥ/GSDₙ of 5.366/1.207/1.226. There were no particles greater than 16 μm in size. About 5.85% of the particles were 3 μm or less in size (a measure of the fines content.) BET analysis revealed an internal surface area of 4.55 m₂/g, a pore size of 190 Å in diameter and a pore volume of 0.7 mL/g.

The present disclosure has been described with reference to exemplary embodiments. Modifications and alterations can occur on reading and understanding the preceding detailed description. It is intended that the present disclosure be construed as including all such modifications and alterations insofar as coming within the scope of the appended claims or the equivalents thereof.

1. A population of porous particles comprising:
a D50 of from about 3 to about 25 μm in size and a GSDᵥ or GSDₙ of less than about 1.35, wherein a particle of said population comprises at least one polyester polymer and comprises one or both of the following:
a pore size of less than about 500 Å; and
a pore volume of greater than about 0.1 ml/g,
wherein the population of porous particles is produced by:
providing an aggregated particle slurry; and
subjecting the aggregated the particle slurry to a continuous coalescence process at a temperature of at least 120° C. to form porous particles comprising;

2. The population of claim 1, wherein said particles further comprise a material selected from the group consisting of: a colorant, a wax and a shell.

3. The population of claim 1, wherein said particles are biodegradable.

4. The population of claim 1, wherein said particles comprise a crystalline resin.

5. The population of claim 1, wherein said particles comprise at least one amorphous resin.

6. The population of claim 1, wherein said population of particles comprises a pore volume of greater than about 0.2 ml/g.

7. The population of claim 1, wherein said population of particles comprises a BET surface area greater than about 4 m²/g.

8. The population of claim 1, wherein said population of particles comprises a pore size of less than about 400 Å.

9. The population of claim 1, wherein said population of particles comprise a BET surface area greater than about 4.25 m²/g.

10. A method of manufacturing porous particles comprising:
providing an aggregated particle slurry comprising particles including at least one polyester resin, and optionally one or more of an emulsifying agent, a colorant, a wax or a chelator;
subjecting the aggregated the particle slurry to a continuous coalescence process at a temperature of at least 120° C.; and
quenching the temperature to below a glass transition temperature of the one or more resins to halt the coalescence to form porous particles having a D50 of from about 3 to about 25 μm in size and a GSDᵥ or GSDₙ of less than about 1.35.

11. The method of claim 10, wherein the particles of the aggregated particle slurry further comprise a shell.

12. The method of claim 10, wherein the particles of the aggregated particle slurry further comprise a colorant or a wax.

13. The method of claim 10, wherein the particles have a residence time of from about 0.5 minutes to about 5 minutes in the continuous coalescence process.

14. The method of claim 10, wherein the porous particles are biodegradable.

15. A toner comprising a plurality of porous particles wherein the porous particles have a D50 of from about 3 to about 25 μm in size and a GSDᵥ or GSDₙ of less than about 1.35, wherein the porous particles comprise at least one polyester polymer, wherein the plurality of porous particles is produced by:
providing an aggregated particle slurry; and
subjecting the aggregated the particle slurry to a continuous coalescence process at a temperature of at least 120° C. to form the plurality of porous particles.

16. The toner of claim 15, wherein the porous particles have a pore size of less than about 500 Å.

17. The toner of claim 15, wherein the porous particles have a pore volume of greater than about 0.1 ml/g,

18. The toner of claim 15, wherein the porous particles comprise a crystalline resin, an amorphous resin or both.

19. The toner of claim 15, wherein the porous particles have a residence time of from about 0.5 minutes to about 5 minutes in the continuous coalescence process.

20. The toner of claim 15, wherein the porous particles further comprise a material selected from the group consisting of: a colorant, a wax and a shell.
